(19) United States
(12) Patent Application Publication
(10) Pub. No.: US 2025/0212111 A1
(43) Pub. Date: Jun. 26, 2025

(54) METHODS AND DEVICES FOR SELECTING A RADIO COMMUNICATION NETWORK

(71) Applicant: Intel Corporation, Santa Clara, CA (US)

(72) Inventors: Qing De XIA, Shanghai (CN); Jun HE, Shanghai (CN); Naga Krishna Mohan DODDASOMAYAJULA, Bangalore (IN); Zhiqiang CAI, Shanghai (CN)

(21) Appl. No.: 18/954,584

(22) Filed: Nov. 21, 2024

Related U.S. Application Data
(63) Continuation of application No. PCT/CN2023/141600, filed on Dec. 25, 2023.

(51) Int. Cl. H04W 48/20; H04W 48/16; H04W 72/54

(52) U.S. Cl. CPC H04W 48/20; H04W 48/16; H04W 72/54

(57) ABSTRACT

A method for selecting a radio communication network may include determining a plurality of first and second radio communication networks available respectively for a first and second radio communication terminals, wherein the plurality of second radio communication networks is at least partially identical to the plurality of first radio communication networks, determining first and second link metrics for each of the first and second radio communication networks, the first and second link metrics representing a link quality for a respective link between a radio communication terminal and a radio communication network, selecting a radio communication network that is included in the plurality of first and second radio communication networks based on the first and second link metrics, and instructing the first and second radio communication terminals to establish a communication link to the selected radio communication network.

### CROSS-REFERENCE TO RELATED APPLICATIONS

This is a domestic bypass continuation of International Application PCT/CN2023/141600, which was filed on Dec. 25, 2023, the entire contents of which are incorporated herein by reference.

### TECHNICAL FIELD

Various aspects of this disclosure generally relate to methods and devices for selecting a radio communication network. By way of example, various aspects relate to determining and selecting a radio communication network for two radio communication terminals, such that the two radio communication terminals may exchange data via the selected radio communication network.

### BACKGROUND

Nowadays, Multi-Device Experience, MDE, allows users to use multiple devices at the same time, such as for example using a laptop computer and a mobile device (e.g. a tablet or a smartphone), connected to each other, enabling for example the devices to synchronize, to reply to an SMS on the computer, to mirror the mobile screen on the computer, etc.

However, in order to ensure a smooth and seamless user-interaction when the devices are connected to each other, MDE may require a lot of bandwidth and low latency, in particular when several MDE applications are running simultaneously. For example, the handling at the same time of a mobile video call while the screen is mirrored/extended between the devices, while data is shared between the devices, may require a lot of resources.

Existing network connection management solutions typically are not optimized to handle such MDE specific use cases, and therefore may result in performance degradation or usage breakup.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. It should be understood that the drawings are diagrammatic and schematic representations of exemplary aspects of the invention, and are neither limitative nor necessarily drawn to scale. In the following description, various embodiments and aspects of the invention are described with reference to the following drawings, in which:

FIG. 1 shows an exemplary radio communication network selection according to some aspects;

FIG. 2 shows an exemplary flowchart of a method to select a radio communication network for MDE data traffic;

FIG. 3 shows an exemplary device according to some aspects;

FIG. 4 shows an exemplary radio communication terminal device according to some aspects;

FIG. 5 shows a flowchart illustrating a method for selecting a radio communication network according to some aspects.

### DESCRIPTION

The following detailed description refers to the accompanying drawings that show, by way of illustration, specific details and aspects of the invention.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural”, “plurality” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The phrases “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The phrases “proper subset”, “adjust subset”, and “lesser subset” refer to a subset of a set that is not equal to the set, illustratively, referring to a subset of a set that contains less elements than the set.

The phrase “at least one of” with regard to a group of elements may be used herein to mean at least one element from the group including the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit, and may also be referred to as a “processing circuit,” “processing circuitry,” among others. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field

Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality, among others, and conversely that any single processor, controller, or logic circuit detailed herein may be realized as two (or more) separate entities with equivalent functionality, among others.

Various aspects of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. For purposes of this disclosure, radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (GSM), Code Division Multiple Access 2000 (CDMA2000), Universal Mobile Telecommunications System (UMTS), Long Term Evolution (LTE), General Packet Radio Service (GPRS), Evolution-Data Optimized (EV-DO), Enhanced Data Rates for GSM Evolution (EDGE), High Speed Packet Access (HSPA; including High Speed Downlink Packet Access (HSDPA), High Speed Uplink Packet Access (HSUPA), HSDPA Plus (HSDPA+), and HSUPA Plus (HSUPA+)), Worldwide Interoperability for Microwave Access (WiMax), 5G New Radio (NR), for example, and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

Unless explicitly specified, the term “transmit” encompasses both direct (point-to-point) and indirect transmission (via one or more intermediary points). Similarly, the term “receive” encompasses both direct and indirect reception. Furthermore, the terms “transmit”, “receive”, “communicate”, and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e. unidirectional or bidirectional communication in one or both of the incoming and outgoing directions.

The term “calculate” encompass both ‘direct’ calculations via a mathematical expression/formula/relationship and ‘indirect’ calculations via lookup or hash tables and other array indexing or searching operations. The term “determine” encompass both ‘direct’ determinations via a mathematical expression/formula/relationship and ‘indirect’ determinations via lookup or hash tables and other array indexing or searching operations.

In the following, examples and embodiments of the selection of a radio communication network for a so-called Multi-Device Experience, MDE, between two or more radio communication terminal devices are described in detail.

In the following exemplary embodiments, the wireless communication network is in particular shown and described with reference to a Wi-Fi network, e.g. a WLAN network in accordance to any IEEE 802.11 standard, and the radio communication terminals are in particular shown as a personal computer, PC, and a mobile device such as e.g. a tablet or a smartphone. It should however be understood by those skilled in the art that various changes in form and detail may be made therein, and that the embodiments can be applied to other types of wireless communication networks and to other types of radio communication terminal devices (e.g. Internet of Things, IoT, devices).

Multi-Device Experience, MDE, allows users to use multiple devices at the same time, and ideally to experience a smooth and seamless interaction between the devices, e.g. between a personal computer, PC, and a tablet or a smartphone.

Typically, when two or more devices are to be used for MDE, the devices are in relatively close range of each other, e.g. in the same room or in the same building. The connected devices may e.g. be a few meters apart from each other, less than 10 meters apart from each other, and/or less than 50 meters apart from each other.

However, current existing network connection management solutions may not be adapted to handle all of the MDE specific use cases. In particular, they may not be adapted to ensure an optimal MDE performance, and to correctly prioritize data for MDE when multiple applications are running at the same time.

A problem that may occur is for example that the devices may not always be connected to the same wireless (radio) communication network, e.g. to the same Wi-Fi network (WLAN network according to an IEEE 802.11 standard). Certain high throughput (bandwidth) and low latency MDE cases such as e.g. screen mirroring from a mobile device to a PC, or screen extension from a PC screen to a tablet, may not function properly (and/or not function at all) if the devices are not connected to the same wireless communication network.

Further problems that may occur are that the data traffic is not balanced correctly, and/or that data for MDE is not assigned a correct priority level, e.g. that MDE data is assigned a lower priority level than other data. This may cause a slow and sluggish user experience, especially when low latency and high-bandwidth MDE applications such as screen mirroring are used in parallel to other applications and data traffic.

A further problem that may occur is when at least one terminal device is connected simultaneously to both wireless (e.g. Wi-Fi) and non-wireless (e.g. Ethernet) internet. In this case, the non-wireless data traffic is often assigned a higher priority level than the wireless data traffic. This may cause data used for MDE to be incorrectly mapped over a non-wireless router.

In order to ensure a smooth and seamless user-interaction, there is therefore a need to provide efficient methods and devices in order to improve and optimize MDE data traffic performance, and in particular to improve network connection management for MDE data and applications.

In the following, the expression “MDE data” is used to describe data that is used when two or more terminal devices are connected to a same wireless communication network, and exchange data over said network. For simplicity, it is further assumed that only two terminal devices are connected to exchange MDE data.

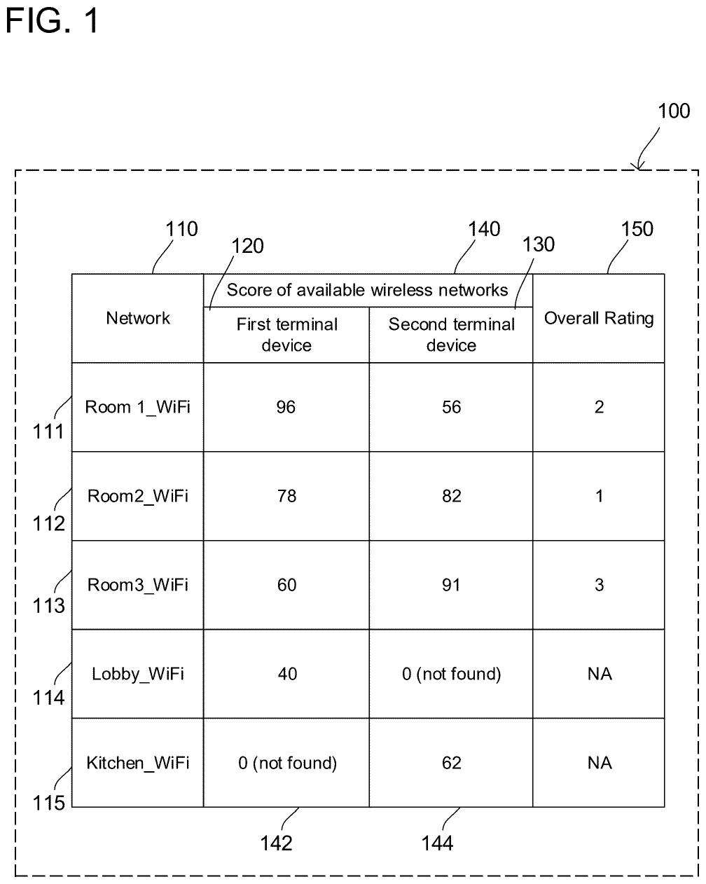

FIG. 1 illustrates an exemplary radio communication network selection 100 according to some aspects.

In the example of FIG. 1, five different radio (wireless) communication networks (access points) 110 may be available to a first radio communication terminal device 120, e.g. a PC, and to a second radio communication terminal device 130, e.g. a mobile device such as a tablet or a smartphone. The available wireless communication networks 111, 112, 113, 114 and 115 may for example be Wi-Fi communication networks (Wi-Fi access points).

As can be seen in FIG. 1, each wireless communication network is attributed a network score 140. The network score 140 may be understood as a network “health” score, and is an indication of the communication quality of a respective communication link between the terminal devices 120 and 130 and a respective wireless communication network. The first column of the network scores 142 are the network scores that have been determined for terminal device 120, and the second column 144 the network scores that have been determined for terminal device 130. The wireless communication networks 111, 112, 113, 114 and 115 are then attributed an overall rating 150, based e.g. on a weighted average of the network scores 140.

It should be noted that the calculation of the network scores may be performed by both terminal devices, by only one of the terminal devices or by an outside device. One or both terminal devices may for example be configured to periodically scan and find all available wireless access points, and to score them in accordance with a set of (link) metrics, such as e.g. RSSI, channel bandwidth, signal quality, etc. However, in general, the terminal devices 120 and 130 may only receive the network scores of the available wireless access points, or only receive a notification instructing them to a connect to one of the available wireless communication networks.

Without any MDE considerations, the terminal devices are typically configured to connect to the radio network with the best communication quality, i.e. with the highest network score. Therefore, as can be seen in FIG. 1, terminal device 120 would normally choose to connect to radio communication network 111, since it has the highest network score of 96, and terminal device 130 to radio communication network 113, since it has the highest network score of 91.

However, when the terminal devices are to be connected and used for MDE, they preferably should be connected to the same wireless (radio) communication network, else MDE applications such as screen mirroring, video calls, etc., may not function properly and/or be slow. In other words, to ensure the best performance and user experience for MDE, both devices should always be connected to the same wireless communication network.

Therefore, according to some aspects, a weighted estimation (e.g. average) of both network ratings is used to decide which wireless communication network the devices should establish a communication link with, so that MDE data can be exchanged between them via said communication link.

The weighted estimated (average) network rating calculations can be performed according to one or more link metrics such as e.g. RSSI, channel bandwidth, signal quality, etc. The calculations may be performed by one of the terminal devices, e.g. by terminal device 120 (e.g. a PC) or be performed by an outside device. If performed by an outside device, the outside device is further configured to instruct both radio terminal devices 120 and 130 to connect to the selected wireless communication network for MDE.

As can be seen in FIG. 1, the best suited wireless communication network for MDE, i.e. the network with the highest average network score (average score of 80), is wireless communication network 112.

Terminal devices 120 and 130 are configured to receive instructions instructing them to establish a communication link with the selected wireless communication network for MDE, i.e. with radio communication network 112 in the example of FIG. 1, and to exchange MDE data over the selected network.

The device having performed the network score calculations will typically be the one instructing both terminal devices 120 and 130 to establish a communication link with the selected wireless communication network.

If either terminal device fails to connect to the selected wireless communication network, the next best suited wireless communication network (for MDE) is selected, and both devices are again instructed to establish a communication link to said network.

Once both terminal devices 120 and 130 are connected to the same wireless network, MDE data traffic can be exchanged between them.

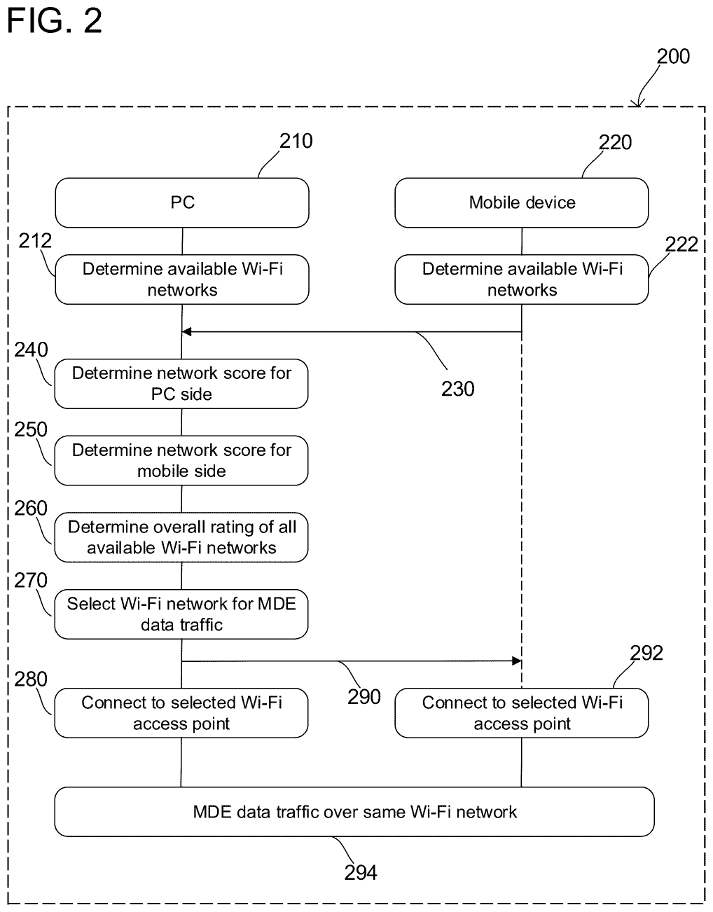

FIG. 2 shows an exemplary flowchart 200 of a method to select a radio (wireless) communication network for MDE data traffic.

In FIG. 2, the first terminal device (corresponding e.g. to terminal device 120) is a PC 210, and the second terminal device (corresponding e.g. to terminal device 130) is a mobile device 220. It should be noted that other types of terminal devices may be used, such as e.g. Internet of Things, IoT, devices or gaming devices.

The PC 210 and the mobile device 220 are configured to determine 212/222, e.g. scan, at predefined time intervals, e.g. periodically, a list of the wireless communication networks available to them.

After determining the list of available wireless communication networks, the mobile device 220 is configured to send 230 the determined list to the PC 210. The mobile device 220 may further be configured to send the list of wireless communication networks available regularly, e.g. periodically, e.g. at predefined time intervals, to the PC 210.

The PC 210 is configured to determine 240 network “health” scores for the available wireless communication networks on the PC side, and to determine 250 network scores for the list (received from mobile device 220) of available wireless communication networks on the mobile side.

The PC 210 is further configured to determine 260 a weighted (e.g. average) rating of all the available wireless communication networks, and to select 270 a (top-rated) wireless communication network, wherein the selected (top-rated) wireless communication network has to be available to both the PC 210 and the mobile device 220.

The PC 210 is further configured to establish a communication link 280 to the selected wireless communication network, and to instruct 290 the mobile device 220 to also establish 292 a communication to the selected wireless communication network. Alternatively, the PC 210 may be configured to only inform (e.g. via a notification, system message, etc.) the mobile device 220 about the selected wireless communication network for MDE data traffic.

Once both the PC 210 and the mobile device 220 have established a communication link to the selected wireless communication network, MDE data traffic will run 294 over the selected wireless communication network.

The flowchart of FIG. 2 illustrates how to ensure that the data used for MDE is exchanged between the terminal devices over the same wireless communication network.

However, to further improve the connection quality and speed for exchanging MDE data between the terminal devices, further policies are required, in particular to balance the overall data traffic, and to assign priority levels to every type of data (MDE and non-MDE data).

In the following, methods, policies and algorithms for both wireless and non-wireless network connections, and for MDE data and non-MDE data will be described in detail.

Furthermore, in the following, the example illustrated by FIG. 2 is assumed for simplicity, i.e. one of the terminal devices, namely PC 210, is configured to determine the network scores via link metrics, to select a wireless communication network for MDE data traffic, and to instruct both PC 210 and mobile device 220 to establish a communication link to the selected wireless communication network. It should however be understood by those skilled in the art that various changes in form and detail may be made therein, and that other devices may be configured to apply the following described methods and policies.

The PC 210 is configured to detect the recipient(s) of the current data traffic, in other words to detect the application for the current data traffic, and in particular to detect if the current data traffic is for MDE or not. The PC 210 is further configured to (try to) schedule all of the MDE data traffic over the previously selected wireless communication network between the terminal devices, i.e. over a selected wireless adapter. The PC will (try to) schedule the non-MDE data traffic over other network adapters in order to balance the overall network load.

The mobile device 220 is configured to regularly, e.g. at predefined time intervals, scan to detect all of the available wireless networks, and to regularly send the list of available wireless networks to the PC 210.

The mobile device 220 is further configured to notify the PC 210 when it changes connection to a different wireless network, e.g. because a user disabled the currently selected wireless network. This ensures that certain MDE data traffic can still continue, such as e.g. file sharing, however some MDE applications requiring a lot of bandwidth and/or a low latency may suffer as a result of changing wireless networks. As soon as the best suited (optimal) wireless network for MDE is available again on the mobile side, the PC 210 is configured to instruct the mobile device 220 to (re-) connect to said wireless network.

When the wireless communication network supports multiple bands, e.g. a Wi-Fi network supporting the 2.4 GHz and 5 GHz bands, the PC 210 is configured to (try to) schedule all of the MDE data traffic on one band, and all of the non-MDE data traffic on another band. The PC 210 is further configured to monitor and determine which band is best suited to schedule the MDE traffic on, based e.g. on the current network traffic load and on the network bandwidth.

For example, assuming a Wi-Fi network supporting dual band (e.g. 2.4 GHz and 5 GHz), the PC will monitor data traffic. If the PC 210 determines that MDE data traffic is currently heavy, while there non-MDE traffic is lighter, the PC 210 will assign the 5 GHz band for MDE data traffic, and the 2.4 GHz band for non-MDE data traffic. In this case, the PC 210 typically does not need to instruct the mobile device 220 on which band it should connect to.

However, in case that the (Wi-Fi) bands are on different subnetwork domains, the PC 210 is configured to select one band for MDE data and one for non-MDE data based on run-time traffic load and network bandwidth, and to instruct the mobile device 220 to connect to the Wi-Fi band determined for MDE data traffic.

TABLE 1
Exemplary priority mapping of MDE data traffic

| | | | TCP/ |
|---|---|---|---|
| | | MDE | IP |
| User-case | Purpose | traffic priority | Port |
| Mobile | Make mobile voice call | 1 - Immediate | 1001 |
| voice call | on PC | | |
| Mobile | Make mobile video call | 1 - Immediate | 1002 |
| video call | on PC | | |
| Screen | To mirror mobile | 2 - Real time | 1003 |
| mirroring | screen on PC | | |
| Screen | To extend PC screen to | 2 - Real time | 1004 |
| extension | mobile | | |
| External | To use mobile camera | 3 - Streaming | 1005 |
| camera | webcam for PC | | |
| File | Bi-directional files | 4 - Large downloads | 1006 |
| sharing | transfer | | |
| Gallery | Sync mobile gallerys | 5 - Large downloads | 1007 |
| sync | photo to PC | | |

In the following, the wireless communication networks are Wi-Fi networks. In case the MDE data traffic is scheduled over a Wi-Fi network (or one band of the Wi-Fi network) and non-MDE data traffic is scheduled over other networks (e.g. Ethernet), or over a different band of the Wi-Fi network, the MDE data traffic can be categorized in accordance with Table 1 below.

As can be seen from Table 1, each type of MDE data, such as mobile voice calls, screen mirroring, synchronization data etc., are assigned different priority levels, depending on the latency and bandwidth requirements. For example, extending the screen of the PC 210 to the screen of the mobile device 220, while being similar to streaming, requires a higher real-time demand and a lower caching latency than typical streaming media, such as e.g. Youtube. Accordingly, “screen extension” type of data is assigned a higher priority level than “streaming” type of data.

As can further be seen from Table 1, each user-case is assigned a unique TCP/IP port. The PC 210 is configured to provide a mapping table such as the one illustrated in Table 1 to a networking management software (e.g. Intel® Connectivity Performance Suite, ICPS, or Intel® Killer™ Performance Suite). The networking management software may be configured to detect the TCP/IP ports used for MDE data traffic, and to schedule further MDE data traffic based on the received mapping table, i.e. based on a fine granularity prioritization at the TCP/IP port level.

In case the MDE data traffic and the non-MDE data traffic are scheduled over the same Wi-Fi network (on the same band of the Wi-Fi network), the PC 210 is configured to provide a common combined (re-) mapping of the priority levels for both MDE and non-MDE data traffic, as illustrated in the exemplary Table 2 and Table 3 below.

TABLE 2
Exemplary MDE and non-MDE data priority levels

| Existing priority for non-MDE data | | MDE user-case priority | |
|---|---|---|---|
| Voice & Video calls | 1 | Mobile voice/video calls | 1 |
| Gaming | 2 | Screen mirroring | 2 |
| Streaming | 3 | Screen extension | 2 |
| Productivity | 3 | External camera | 3 |
| Downloads | 4 | PC-mobile file sharing | 4 |
| . . . | . . . | Mobile gallery snyc | 5 |
| . . . | . . . | . . . | . . . |

TABLE 3
Combined Priority Map for MDE data and non-MDE data
Combined data priority

| | |
|---|---|
| Voice & Video calls | 1 |
| Mobile voice/video calls | 1 |
| Gaming | 2 |
| Screen mirroring | 3 |
| Screen extension | 3 |
| Streaming | 4 |
| Productivity | 4 |
| External camera | 4 |
| Downloads | 5 |
| PC-mobile file sharing | 5 |
| Mobile gallery sync | 6 |
| . . . | . . . |

As can be seen from Table 2 different types of non-MDE data include video and voice call data, gaming data, streaming data, productivity data (e.g. office and work data), downloads, etc.

As can be seen from Table 2 and Table 3, the PC 210 is configured to combine existing priority level policies for data and the MDE user-case priority levels to a single common (combined) priority map for both MDE and non-MDE types of data. The scheduling of both MDE and non-MDE data traffic is then planned according to the common priority map, such as the exemplary common priority map illustrated in Table 3.

Table 4 below provides an overview and summary of the possible policies for the different possible scenarios.

TABLE 4
Summary of the data routing and traffic prioritization policies

| Available | | |
|---|---|---|
| network(s) | Data path policy | Prioritization Policy |
| Single band | All data traffic over Wi-Fi network | Combined data traffic prioritization |
| Wi-Fi | | map |
| Dual band | MDE data traffic over one band (e.g. | Separate data traffic prioritization |
| Wi-Fi | 5 GHz) | MDE data prioritization according |
| | Non-MDE data traffic over another band | to TCP/IP ports |
| | (e.g. 2.4 GHz) | Non-MDE data prioritization |
| | | according to existing rules |
| Single band | MDE data over Wi-Fi | Separate data traffic prioritization |
| Wi-Fi | Non-MDE data over another network | MDE data prioritization according |
| Ethernet | | to TCP/IP ports |
| Cellular | | Non-MDE data prioritization |
| | | according to existing rules |
| Dual band | MDE data over Wi-Fi, selection of best | Separate data traffic prioritization |
| Wi-Fi | band according to link metrics | MDE data prioritization according |
| Ethernet | Non MDE data traffic over another Wi- | to TCP/IP ports |
| Cellular | Fi band, or another network | Non-MDE data prioritization |
| | | according to existing rules |

As can be seen from Table 4, the combined data prioritization map is only used when all of the data traffic occurring for the PC 210 and the mobile device 220 runs over the same Wi-Fi network (same band of the Wi-Fi network). When for example ethernet is also available on the PC side, the PC 210 may determine to send MDE data over the Wi-Fi network, and non-MDE data over the wired ethernet connection.

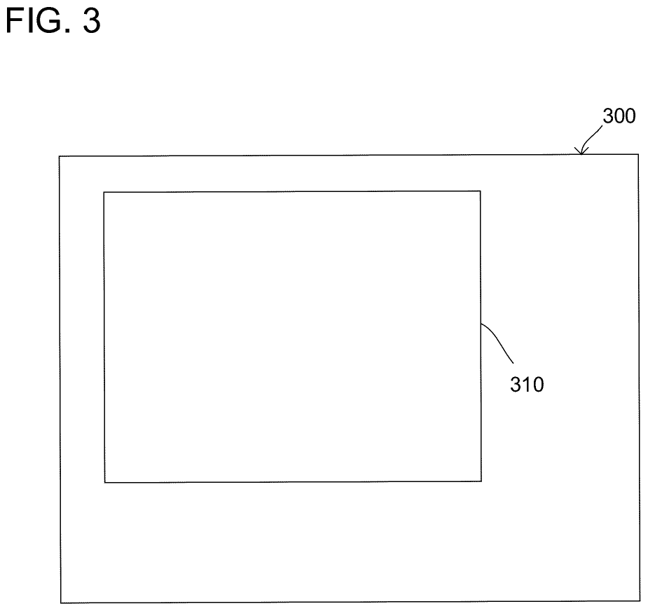

FIG. 3 illustrates an exemplary device 300 according to some aspects.

The exemplary device 300 includes a processor 310. The processor 310 is configured to determine a plurality of first and second radio communication networks available to a first radio communication terminal and to a second radio communication terminal.

The processor 310 is further configured to determine link metrics for the first and second radio communication terminals, e.g. link metrics based on network traffic load and/or on network bandwidth, wherein the link metrics represent a link quality for a respective link between the radio communication terminals and a respective radio communication network from the plurality of first and second radio communication networks.

After having determined the link metrics, the processor 310 is configured to select a radio communication network that is included in the plurality of first and second radio communication networks based on the determined first and second link metrics.

After selecting the radio communication network, the processor 310 is configured to instruct both the first and the second radio communication terminals to establish a communication link, wherein the communication link includes a first link from the first radio communication terminal to the selected radio communication network and a second link from the second radio communication terminal to the selected radio communication network.

Once the communication link between the two terminal devices is established, MDE data traffic can be scheduled by processor 310 to be exchanged between the first and the second radio communication terminal.

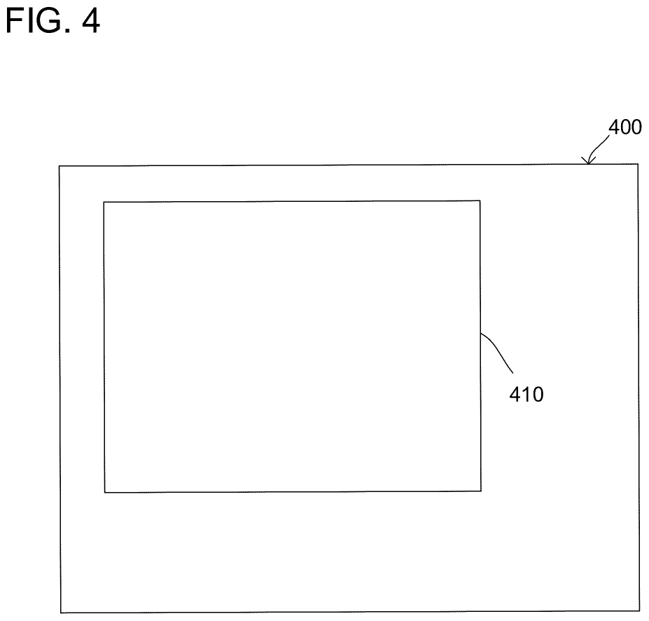

FIG. 4 illustrates an exemplary radio communication terminal device 400 according to some aspects.

The radio communication terminal device 400 includes a processor 410. The processor 410 is configured to determine a plurality of first radio communication networks available to the radio communication terminal device 400.

The processor 410 is configured to receive a plurality of second radio communication networks available to a further radio communication terminal device, wherein the plurality of second radio communication networks is at least partially identical to the plurality of first radio communication networks.

The processor 410 is configured to determine a first link metric for each of the determined plurality of first radio communication networks, the first link metric representing a link quality for a respective link between the first radio communication terminal and a respective first radio communication network from the plurality of first radio communication networks.

The processor 410 is configured to determine link metrics for the radio communication terminal device and the further radio communication terminal device, e.g. link metrics based on network (data) traffic load and on network bandwidth, wherein the link metrics represent a link quality for a respective link between the radio communication terminal devices and a respective radio communication network from the plurality of first and second radio communication networks.

After having determined the link metrics, the processor 410 is configured to select a radio communication network that is included in the plurality of first and second radio communication networks based on the (determined) first and second link metrics.

The processor 410 is further configured to instruct radio communication terminal device 400 to establish a communication link from the radio communication terminal to the selected radio communication network, and to instruct to send a notification to the further radio communication terminal device, instructing it to establish a communication link from the further radio communication terminal to the selected radio communication network.

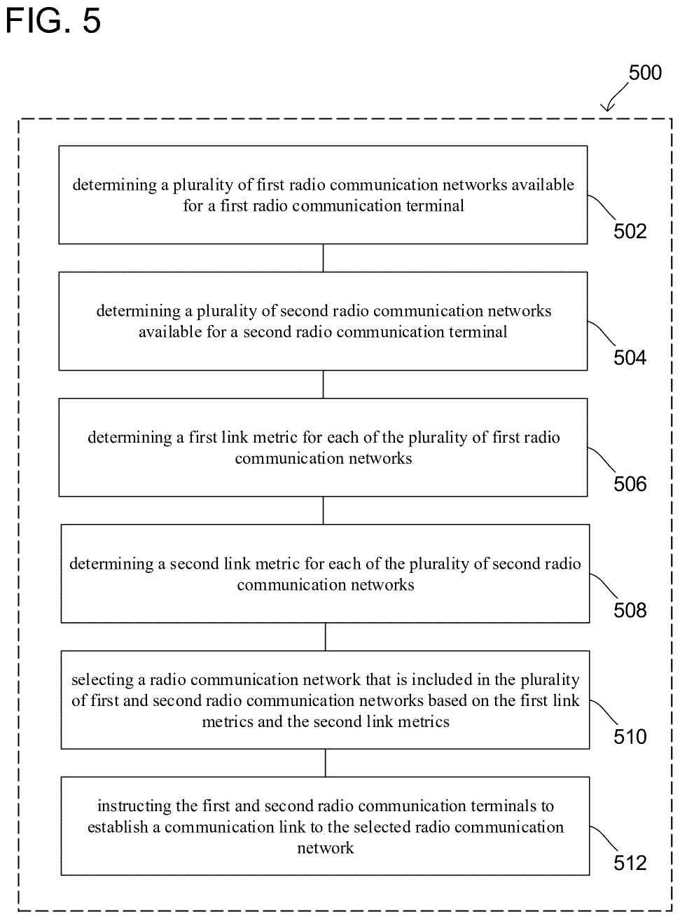

FIG. 5 shows a flowchart illustrating a method 500 for selecting a radio communication network according to some aspects. As shown in FIG. 5, the method 500 includes determining 502 a plurality of first radio communication networks available for a first radio communication terminal, determining 504 a plurality of second radio communication networks available for a second radio communication terminal, wherein the plurality of second radio communication networks is at least partially identical to the plurality of first radio communication networks, determining 506 a first link metric for each of the determined plurality of first radio communication networks, the first link metric representing a link quality for a respective link between the first radio communication terminal and a respective first radio communication network from the plurality of first radio communication networks, determining 508 a second link metric for each of the determined plurality of second radio communication networks, the second link metric representing a link quality for a respective link between the second radio communication terminal and a respective second radio communication network from the plurality of second radio communication networks, selecting 510 a radio communication network that is included in the plurality of first radio communication networks and in the plurality of second radio communication networks based on the first link metrics and the second link metrics, and instructing 512 the first radio communication terminal and the second radio communication terminal to establish a communication link, wherein the communication link includes a first link from the first radio communication terminal to the selected radio communication network and a second link from the second radio communication terminal to the selected radio communication network.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

The following examples disclose various aspects of this disclosure:

Example 1 is a device including a processor. The processor may be configured to determine a plurality of first radio communication networks available for a first radio communication terminal, determine a plurality of second radio communication networks available for a second radio communication terminal, wherein the plurality of second radio communication networks is at least partially identical to the plurality first radio communication networks, determine a first link metric for each of the (determined) plurality of first radio communication networks, the first link metric representing a link quality for a respective link between the first radio communication terminal and a respective first radio communication network from the plurality of first radio communication networks, determine a second link metric for each of the (determined) plurality of second radio communication networks, the second link metric representing a link quality for a respective link between the second radio communication terminal and a respective second radio communication network from the plurality of second radio communication networks, select a radio communication network that is included in the plurality of first radio communication networks and in the plurality of second radio communication networks based on the first link metrics and the second link metrics, and instruct the first radio communication terminal and the second radio communication terminal to establish a communication link, wherein the communication link includes a first link from the first radio communication terminal to the (selected) radio communication network and a second link from the second radio communication terminal to the (selected) radio communication network.

In Example 2, the subject matter of Example 1 can optionally include that the device is configured as a radio communication terminal, and that the processor is further configured to instruct to provide and receive data via the (established) communication link, and instruct to operate on the data exchanged between the first radio communication terminal and the second radio communication terminal via the (established) communication link.

In Example 3, the subject matter of Example 2 can optionally include that the exchanged data includes at least one data type from a group consisting of: mobile voice call data, mobile video call data, screen mirroring data, screen extension data, external camera data, multi-device file sharing data and synchronization data.

In Example 4, the subject matter of Example 3 can optionally include that the processor is further configured to determine a priority level out of a plurality of priority levels for the different types of data exchanged between the first and second radio communication terminals via the communication link.

In Example 5, the subject matter of any one of Examples 2 to 4 can optionally include that the processor is further configured to determine a further communication network different than the radio communication network selected to exchange data between the first radio communication terminal and the second radio communication terminal, and instruct at least one of the first and second radio communication terminals to establish a communication link over the further communication network to transmit and/or receive further data, wherein the further data is different than the data exchanged between the first and second radio communication terminals via the communication link.

In Example 6, the subject matter of any one of Examples 3 or 4 can optionally include that the processor is further configured to determine that data is to be transmitted and received over the (selected) radio communication network via the communication link, determine a priority level out of a plurality of priority levels for the (at least one) different types of data exchanged between the first and second radio communication terminal via the communication link, and determine a priority level out of a plurality of priority levels for the different types of further data.

In Example 7, the subject matter of Example 6 can optionally include that the processor is further configured to determine a common priority list for the different types of data exchanged between the first and second radio communication terminal via the communication link and the different types of further data.

In Example 8, the subject matter of any one of Examples 6 or 7 can optionally include that the further data includes at least one data type from a group consisting of: voice call data, video call data, gaming data, streaming data and office/work data.

In Example 9, the subject matter of any one of Examples 2 to 8 can optionally include that the (selected) radio communication network, the first radio communication terminal and the second radio communication terminal support at least dual band, and that the processor is further configured to determine a first band on which data can be exchanged between the first radio communication terminal and the second radio communication terminal, and determine a second band on which further data can be transmitted and received, wherein the second band is different from the first band.

In Example 10, the subject matter of any one of Examples 2 to 8 can optionally include that the (selected) radio communication network, the first radio communication terminal and the second radio communication terminal support at least dual band, and that the processor is further configured to determine a band, based on the first link metrics and the second link metrics, on which data can be exchanged between the first and second radio communication terminals, and determine a further communication network, different than the (selected) radio communication network, to transmit and receive further data.

In Example 11, the subject matter of any one of Examples 2 to 10 can optionally include that the processor is further configured to determine a priority level out of a plurality of priority levels for different types of data exchanged between the first and second radio communication terminals, and determine a TCP/IP port for each type of data based on its (determined) priority level.

In Example 12, the subject matter of any one of Examples 1 to 11 can optionally include that the plurality (and in particular the selected) of radio communication networks are Wireless Fidelity, Wi-Fi, networks.

In Example 13, the subject matter of any one of Examples 1 to 12 can optionally include that the processor is further configured to determine, at predefined time intervals, the first link metrics for the first plurality of radio communication networks and the second link metrics for the second plurality of radio communication, and select, at predefined time intervals, a radio communication network that is included in the plurality of first radio communication networks and in the plurality of second radio communication networks based on the first link metrics and the second link metrics.

In Example 14, the subject matter of any one of Examples 1 to 13 can optionally include that the processor is further configured to select a radio communication network that is included in the plurality of first radio communication networks and in the plurality of second radio communication networks based on a weighted estimation of the first link metrics and the second link metrics.

In Example 15, the subject matter of any one of Examples 1 to 14 can optionally include that the processor is further configured to select a radio communication network that is included in the plurality of first radio communication networks and in the plurality of second radio communication networks based on a weighted average of the first link metrics and the second link metrics.

In Example 16, the subject matter of any one of Examples 1 to 15 can optionally include that the first link metrics and the second link metrics are based on network traffic load and/or on network bandwidth.

Example 17 is a radio communication terminal device including a processor. The processor may be configured to determine a plurality of first radio communication networks available to the radio communication terminal device, receive a plurality of second radio communication networks available to a further radio communication terminal device, wherein the plurality of second radio communication networks is at least partially identical to the plurality of first radio communication networks, determine a first link metric for each of the plurality of first radio communication networks, the first link metric representing a link quality for a respective link between the radio communication terminal device and a respective first radio communication network from the plurality of first radio communication networks, determine a second link metric for each of the received plurality of second radio communication networks, the second link metric representing a link quality for a respective link between the further radio communication terminal device and a respective second radio communication network from the plurality of second radio communication networks, select a radio communication network that is included in the plurality of first radio communication networks and in the plurality of second radio communication networks based on the first link metrics and the second link metrics, instruct to establish a communication link from the radio communication terminal device to the (selected) radio communication network, and instruct to send a notification to the further radio communication terminal device instructing it to establish a communication link from the further radio communication terminal device to the (selected) radio communication network.

In Example 18, the subject matter of Example 17 can optionally include that the processor is further configured to instruct to provide and receive data via the communication link, and instruct to operate on the data exchanged between the radio communication terminal device and the further radio communication terminal device via the communication link.

In Example 19, the subject matter of any one of Examples 17 or 18 can optionally include that the radio communication terminal device is at least one of: a personal computer, PC, a mobile device, an Internet of Things, IoT, device, and a gaming device.

In Example 20, the subject matter of any one of Examples 17 to 19 can optionally include further circuitry for transmitting and receiving. The further circuitry may be configured to transmit and receive data over the (selected) radio communication network via the communication link with the further radio communication terminal device.

In Example 21, the subject matter of Example 20 can optionally include that the circuitry for transmitting and receiving is further configured to transmit and receive further data over a communication network different than the (selected) radio communication network.

In Example 22, the subject matter of any one of Examples 18 to 21 can optionally include that the data includes at least one data type from a group consisting of: mobile voice call data, mobile video call data, screen mirroring data, screen extension data, external camera data, multi-device file sharing data and synchronization data.

In Example 23, the subject matter of Example 22 can optionally include that the processor is further configured to determine a priority level out of a plurality of priority levels for the different types of data exchanged between the radio communication terminal device and the further radio communication terminal device via the communication link.

In Example 24, the subject matter of any one of Examples 18 to 23 can optionally include that the processor is further configured to determine a further communication network different than the radio communication network selected to exchange data between the radio communication terminal device and the further radio communication terminal device, and instruct at least one of the radio communication terminal devices to establish a communication link over the further communication network to transmit and/or receive further data, wherein the further data is different data than the data exchanged between the radio communication terminal devices via the communication link.

In Example 25, the subject matter of any one of Examples 18 to 24 can optionally include that the processor is further configured to determine that data is to be transmitted and received over the (selected) radio communication network via the communication link, determine a priority level out of a plurality of priority levels for the different types of data exchanged between the radio communication terminal devices via the communication link, and determine a priority level out of a plurality of priority levels for the different types of further data.

In Example 26, the subject matter of Example 25 can optionally include that the processor is further configured to determine a common priority list for the different types of data exchanged between the communication terminal devices via the communication link and the different types of further data.

In Example 27, the subject matter of any one of Examples 25 or 26 can optionally include that further data includes at least one data type from a group consisting of: voice call data, video call data, gaming data, streaming data and office/work data.

In Example 28, the subject matter of any one of Examples 18 to 27 can optionally include that the (selected) radio communication network, the radio communication terminal device and the further radio communication terminal device support at least dual band, and that the processor is further configured to determine a first band on which data can be exchanged between the communication terminals, and determine a second band on which further data can be transmitted and received, wherein the second band is different from the first band.

In Example 29, the subject matter of any one of Examples 18 to 28 can optionally include that the (selected) radio communication network, the radio communication terminal device and the further radio communication terminal device support at least dual band, and that the processor is further configured to determine a band, based on the first link metrics and the second link metrics, on which data can be exchanged between the radio communication terminal devices, and determine a different communication network than the (selected) radio communication network, to transmit and receive further data.

In Example 30, the subject matter of any one of Examples 18 to 29 can optionally include that the processor is further configured to determine a priority level out of a plurality of priority levels for different types of data exchanged between the radio communication terminal devices, and determine a TCP/IP port for each different type of data based on its (determined) priority level.

In Example 31, the subject matter of any one of Examples 18 to 30 can optionally include that the plurality of radio communication networks are Wireless Fidelity, Wi-Fi, networks.

In Example 32, the subject matter of any one of Examples 18 to 31 can optionally include that the processor is further configured to determine, at predefined time intervals, first link metrics for the first plurality of radio communication networks and second link metrics for the second plurality of radio communication, and select, at predefined time intervals, a radio communication network that is included in the plurality of first radio communication networks and in the plurality of second radio communication networks based on the first link metrics and the second link metrics.

In Example 33, the subject matter of any one of Examples 18 to 32 can optionally include that the processor is further configured to select a radio communication network that is included in the plurality of first radio communication networks and in the plurality of second radio communication networks based on a weighted estimation of the first link metrics and the second link metrics.

In Example 34, the subject matter of any one of Examples 18 to 33 can optionally include that the processor is further configured to select a radio communication network that is included in the plurality of first radio communication networks and in the plurality of second radio communication networks based on a weighted average of the first link metrics and the second link metrics.

In Example 35, the subject matter of any one of Examples 18 to 34 can optionally include that the first link metrics and the second link metrics are based on network traffic load and/or network bandwidth.

Example 36 is a method for selecting a radio communication network. The method may include determining a plurality of first radio communication networks available for a first radio communication terminal, determining a plurality of second radio communication networks available for a second radio communication terminal, wherein the plurality of second radio communication networks is at least partially identical to the first plurality of radio communication networks, determining a first link metric for each of the (determined) plurality of first radio communication networks, the first link metric representing a link quality for a respective link between the first radio communication terminal and a respective first radio communication network from the plurality of first radio communication networks, determining a second link metric for each of the (determined) plurality of second radio communication networks, the second link metric representing a link quality for a respective link between the second radio communication terminal and a respective second radio communication network from the plurality of second radio communication networks, selecting a radio communication network that is included in the plurality of first radio communication networks and in the plurality of second radio communication networks based on the first link metrics and the second link metrics, and instructing the first radio communication terminal and the second radio communication terminal to establish a communication link, wherein the communication link includes a first link from the first radio communication terminal to the (selected) radio communication network and a second link from the second radio communication terminal to the (selected) radio communication network.

In Example 37, the subject matter of Example 36 can optionally include that the method includes instructing the first and second radio communication terminals to provide and receive data via the communication link, and instructing to operate on the data exchanged between the first and second radio communication terminals via the communication link.

In Example 38, the subject matter of Example 37 can optionally include that the data includes at least one data type from a group consisting of: mobile voice call data, mobile video call data, screen mirroring data, screen extension data, external camera data, multi-device file sharing data and synchronization data.

In Example 39, the subject matter of Example 38 can optionally include determining a priority level out of a plurality of priority levels for the different types of data exchanged between the first and second radio communication terminals via the communication link.

In Example 40, the subject matter of any one of Examples 37 to 39 can optionally include determining a further communication network, different than the radio communication network selected to exchange data between the first radio communication terminal and the second radio communication terminal, and instructing at least one of the first and second radio communication terminals to establish a communication link over the further communication network to transmit and/or receive further data, wherein the further data is different than the data exchanged between the first and second radio communication terminals via the communication link.

In Example 41, the subject matter of any one of Examples 37 to 39 can optionally include determining that data is to be transmitted and received over the (selected) radio communication network via the communication link, determining a priority level out of a plurality of priority levels for the different types of data exchanged between the first and second radio communication terminals via the communication link, and determining a priority level out of a plurality of priority levels for the different types of further data.

In Example 42, the subject matter of Example 41 can optionally include determining a common priority list for the different types of data exchanged between the first and second radio communication terminals via the communication link and the different types of further data.

In Example 43, the subject matter of any one of Examples 41 or 42 can optionally include that the further data includes at least one data type from a group consisting of: voice call data, video call data, gaming data, streaming data and office/work data.

In Example 44, the subject matter of any one of Examples 37 to 43 can optionally include that the (selected) radio communication network, the first radio communication terminal and the second radio communication terminal support at least dual band, and further include determining a first band on which data can be exchanged between the first radio communication terminal and the second radio communication terminal, and determining a second band on which further data can be transmitted and received, wherein the second band is different from the first band.

In Example 45, the subject matter of any one of Examples 37 to 43 can optionally include that the (selected) radio communication network, the first radio communication terminal and the second radio communication terminal support at least dual band, and further include determining a band, based on the first link metrics and the second link metrics, on which data can be exchanged between the first and second radio communication terminals, and determining a different communication network than the (selected) radio communication network, to transmit and receive further data.

In Example 46, the subject matter of any one of Examples 37 to 45 can optionally include determining a priority level out of a plurality of priority levels for different types of data exchanged between the first and second radio communication terminals, and determining a TCP/IP port for each different type of data based on its (determined) priority level.

In Example 47, the subject matter of any one of Examples 36 to 46 can optionally include that the plurality (and in particular the selected) of radio communication networks are Wireless Fidelity, Wi-Fi, networks.

In Example 48, the subject matter of any one of Examples 36 to 47 can optionally include determining, at predefined time intervals, first link metrics for the first plurality of radio communication networks and second link metrics for the second plurality of radio communication, and selecting, at predefined time intervals, a radio communication network that is included in the plurality of first radio communication networks and in the plurality of second radio communication networks based on the first link metrics and the second link metrics.

In Example 49, the subject matter of any one of Examples 36 to 48 can optionally include selecting a radio communication network that is included in the plurality of first radio communication networks and in the plurality of second radio communication networks based on a weighted estimation of the first link metrics and the second link metrics.

In Example 50, the subject matter of any one of Examples 36 to 49 can optionally include selecting a radio communication network that is included in the plurality of first radio communication networks and in the plurality of second radio communication networks based on a weighted average of the first link metrics and the second link metrics.

In Example 51, the subject matter of any one of Examples 36 to 50 can optionally include that the first link metrics and the second link metrics are based on network traffic load and/or network bandwidth.

Example 52 is a non-transitory computer readable medium. The non-transitory computer readable medium may include instructions which, when executed by one or more processors, are configured to cause the one or more processors to implement a method for selecting a radio communication network, wherein the method includes determining a plurality of first radio communication networks available for a first radio communication terminal, determining a plurality of second radio communication networks available for a second radio communication terminal, wherein the plurality of second radio communication networks is at least partially identical to the plurality of first radio communication networks, determining a first link metric for each of the (determined) plurality of first radio communication networks, the first link metric representing a link quality for a respective link between the first radio communication terminal and a respective first radio communication network from the plurality of first radio communication networks, determining a second link metric for each of the (determined) plurality of second radio communication networks, the second link metric representing a link quality for a respective link between the second radio communication terminal and a respective second radio communication network from the plurality of second radio communication networks, selecting a radio communication network that is included in the plurality of first radio communication networks and in the plurality of second radio communication networks based on the first link metrics and the second link metrics, and instructing the first radio communication terminal and the second radio communication terminal to establish a communication link, wherein the communication link includes a first link from the first radio communication terminal to the (selected) radio communication network and a second link from the second radio communication terminal to the (selected) radio communication network.

In Example 53, the subject matter of Example 52 can optionally include that the instructions are further configured to cause the one or more processors to: provide and receive data via the communication link, and instruct to operate on the data exchanged between the first and second radio communication terminals via the communication link.

In Example 54, the subject matter of Example 53 can optionally include that the data (exchanged) includes at least one data type from a group consisting of: mobile voice call data, mobile video call data, screen mirroring data, screen extension data, external camera data, multi-device file sharing data and synchronization data.

In Example 55, the subject matter of Example 54 can optionally include that the instructions are further configured to cause the one or more processors to: determine a priority level out of a plurality of priority levels for the different types of data exchanged between the first and second radio communication terminals via the communication link.

In Example 56, the subject matter of any one of Examples 53 to 55 can optionally include that the instructions are further configured to cause the one or more processors to: determine a further communication network different than the radio communication network selected to exchange data between the first radio communication terminal and the second radio communication terminal, and instruct at least one of the first and second radio communication terminals to establish a communication link over the further communication network to transmit and/or receive further data, wherein the further data is different than the data exchanged between the first and second radio communication terminals via the communication link.

In Example 57, the subject matter of any one of Examples 53 to 55 can optionally include that the instructions are further configured to cause the one or more processors to: determine that data is to be transmitted and received over the (selected) radio communication network via the communication link, determine a priority level out of a plurality of priority levels for the different types of data exchanged between the first and second radio communication terminal via the communication link, and determine a priority level out of a plurality of priority levels for the different types of further data.

In Example 58, the subject matter of Example 57 can optionally include that the instructions are further configured to cause the one or more processors to: determine a common priority list for the different types of data exchanged between the first and second radio communication terminal via the communication link and the different types of further data.

In Example 59, the subject matter of any one of Examples 57 or 58 can optionally include that the further data includes at least one data type from a group consisting of: voice call data, video call data, gaming data, streaming data and office/work data.

In Example 60, the subject matter of any one of Examples 53 to 59 can optionally include that the (selected) radio communication network, the first radio communication terminal and the second radio communication terminal support at least dual band, and include that the instructions are further configured to cause the one or more processors to: determine a first band on which data can be exchanged between the first radio communication terminal and the second radio communication terminal, and determine a second band on which further data can be transmitted and received, wherein the second band is different from the first band.

In Example 61, the subject matter of any one of Examples 53 to 59 can optionally include that the (selected) radio communication network, the first radio communication terminal and the second radio communication terminal support at least dual band, and include that the instructions are further configured to cause the one or more processors to: determine a band, based on the first link metrics and the second link metrics, on which data can be exchanged between the first and second radio communication terminals, and determine a different communication network than the (selected) radio communication network, to transmit and receive further data.

In Example 62, the subject matter of any one of Examples 53 to 61 can optionally include that the instructions are further configured to cause the one or more processors to:

determine a priority level out of a plurality of priority levels for different types of data exchanged between the first and second radio communication terminals, and determine a TCP/IP port for each different type of data based on its (determined) priority level.

In Example 63, the subject matter of any one of Examples 52 to 62 can optionally include that the plurality (and in particular the selected) of radio communication networks are Wireless Fidelity, Wi-Fi, networks.

In Example 64, the subject matter of any one of Examples 52 to 63 can optionally include that the instructions are further configured to cause the one or more processors to: determine, at predefined time intervals, first link metrics for the first plurality of radio communication networks and second link metrics for the second plurality of radio communication, and select, at predefined time intervals, a radio communication network that is included in the plurality of first radio communication networks and in the plurality of second radio communication networks based on the first link metrics and the second link metrics.

In Example 65, the subject matter of any one of Examples 52 to 64 can optionally include that the instructions are further configured to cause the one or more processors to: select a radio communication network that is included in the plurality of first radio communication networks and in the plurality of second radio communication networks based on a weighted estimation of the first link metrics and the second link metrics.

In Example 66, the subject matter of any one of Examples 52 to 65 can optionally include that the instructions are further configured to cause the one or more processors to: select a radio communication network that is included in the plurality of first radio communication networks and in the plurality of second radio communication networks based on a weighted average of the first link metrics and the second link metrics.

In Example 67, the subject matter of any one of Examples 52 to 66 can optionally include that the first link metrics and the second link metrics are based on network traffic load and/or network bandwidth.

Example 68 is a device including means for determining a plurality of first radio communication networks available for a first radio communication terminal, means for determining a plurality of second radio communication networks available for a second radio communication terminal, wherein the plurality of second radio communication networks is at least partially identical to the first radio communication networks, means for determining a first link metric for each of the (determined) plurality of first radio communication networks, the first link metric representing a link quality for a respective link between the first radio communication terminal and a respective first radio communication network from the plurality of first radio communication networks, means for determining a second link metric for each of the (determined) plurality of second radio communication networks, the second link metric representing a link quality for a respective link between the second radio communication terminal and a respective second radio communication network from the plurality of second radio communication networks, means for selecting a radio communication network that is included in the plurality of first radio communication networks and in the plurality of second radio communication networks based on the first link metrics and the second link metrics, and means for instructing the first radio communication terminal and the second radio communication terminal to establish a communication link, wherein the communication link includes a first link from the first radio communication terminal to the (selected) radio communication network and a second link from the second radio communication terminal to the (selected) radio communication network.

In Example 69, the subject matter of Example 68 can optionally include that the device is configured as a radio communication terminal, and further include means for instructing to provide and receive data via the communication link, and means for instructing to operate on the data exchanged between the first and second radio communication terminals via the communication link.

In Example 70, the subject matter of Example 69 can optionally include that the data includes at least one data type from a group consisting of: mobile voice call data, mobile video call data, screen mirroring data, screen extension data, external camera data, multi-device file sharing data and synchronization data.

In Example 71, the subject matter of Example 70 can optionally include means for determining a priority level out of a plurality of priority levels for the different types of data exchanged between the first and second radio communication terminals via the communication link.

In Example 72, the subject matter of any one of Examples 69 to 71 can optionally include means for determining a further communication network, different than the radio communication network selected to exchange data between the first radio communication terminal and the second radio communication terminal, and means for instructing at least one of the first and second radio communication terminals to establish a communication link over the further communication network to transmit and/or receive further data, wherein the further data is different than the data exchanged between the first and second radio communication terminals via the communication link.

In Example 73, the subject matter of any one of Examples 69 to 71 can optionally include means for determining that data is to be transmitted and received over the (selected) radio communication network via the communication link, and means for determining a priority level out of a plurality of priority levels for the different types of data exchanged between the first and second radio communication terminal via the communication link, and determine a priority level out of a plurality of priority levels for the different types of further data.

In Example 74, the subject matter of Example 73 can optionally include means for determining a common priority list for the different types of data exchanged between the first and second radio communication terminal via the communication link and the different types of further data.

In Example 75, the subject matter of any one of Examples 73 or 74 can optionally include that the further data includes at least one data type from a group consisting of: voice call data, video call data, gaming data, streaming data and office/work data.

In Example 76, the subject matter of any one of Examples 69 to 75 can optionally include that the (selected) radio communication network, the first radio communication terminal and the second radio communication terminal support at least dual band, and include means for determining a first band on which data can be exchanged between the first radio communication terminal and the second radio communication terminal, and means for determining a second band on which further data can be transmitted and received, wherein the second band is different from the first band.

In Example 77, the subject matter of any one of Examples 69 to 75 can optionally include that the (selected) radio communication network, the first radio communication terminal and the second radio communication terminal support at least dual band, and include means for determining a band, based on the first link metrics and the second link metrics, on which data can be exchanged between the first and second radio communication terminals, and means for determining a different communication network than the (selected) radio communication network to transmit and receive further data.

In Example 78, the subject matter of any one of Examples 69 to 77 can optionally include means for determining a priority level out of a plurality of priority levels for different types of data exchanged between the first and second radio communication terminals, and means for determining a TCP/IP port for each different type of data based on its (determined) priority level.

In Example 79, the subject matter of any one of Examples 68 to 78 can optionally include that the plurality (and in particular the selected) of radio communication networks are Wireless Fidelity, Wi-Fi, networks.

In Example 80, the subject matter of any one of Examples 68 to 79 can optionally include means for determining, at predefined time intervals, first link metrics for the first plurality of radio communication networks and second link metrics for the second plurality of radio communication, and means for selecting, at predefined time intervals, a radio communication network that is included in the plurality of first radio communication networks and in the plurality of second radio communication networks based on the first link metrics and the second link metrics.

In Example 81, the subject matter of any one of Examples 68 to 79 can optionally include means for selecting a radio communication network that is included in the plurality of first radio communication networks and in the plurality of second radio communication networks based on a weighted estimation of the first link metrics and the second link metrics.

In Example 82, the subject matter of any one of Examples 68 to 81 can optionally include means for selecting a radio communication network that is included in the plurality of first radio communication networks and in the plurality of second radio communication networks based on a weighted average of the first link metrics and the second link metrics.

In Example 83, the subject matter of any one of Examples 68 to 82 can optionally include that the first link metrics and the second link metrics are based on network traffic load and/or network bandwidth.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A device comprising:
a processor configured to:
determine a plurality of first radio communication networks available for a first radio communication terminal;
determine a plurality of second radio communication networks available for a second radio communication terminal, wherein the second plurality of radio communication networks is at least partially identical to the first plurality of radio communication networks;
determine a first link metric for each of the plurality of first radio communication networks, the first link metric representing a link quality for a respective link between the first radio communication terminal and a respective first radio communication network from the plurality of first radio communication networks;
determine a second link metric for each of the plurality of second radio communication networks, the second link metric representing a link quality for a respective link between the second radio communication terminal and a respective second radio communication network from the plurality of second radio communication networks;
select a radio communication network that is included in the plurality of first radio communication networks and in the plurality of second radio communication networks based on the first link metrics and the second link metrics; and
instruct the first radio communication terminal and the second radio communication terminal to establish a communication link, wherein the communication link comprises a first link from the first radio communication terminal to the radio communication network and a second link from the second radio communication terminal to the radio communication network.

2. The device of claim 1,
configured as a radio communication terminal;
wherein the processor is further configured to:
instruct to provide and receive data via the communication link; and
instruct to operate on the data exchanged between the first radio communication terminal and the second radio communication terminal via the communication link.

3. The device of claim 2, wherein the data comprises at least one data type from a group consisting of:
mobile voice call data;
mobile video call data;
screen mirroring data;
screen extension data;
external camera data;
multi-device file sharing data; and
synchronization data.

4. The device of claim 3, wherein the processor is further configured to:
determine a priority level out of a plurality of priority levels for the at least one data type of data exchanged between the first radio communication terminal and the second radio communication terminal via the communication link.

5. The device of claim 2, wherein the processor is further configured to:
determine a further communication network, wherein the further communication network is different than the radio communication network to exchange data between the first radio communication terminal and the second radio communication terminal; and
instruct at least one of the first radio communication terminal and the second radio communication terminal to establish a further communication link over the further communication network to transmit and/or receive further data, wherein the further data is different than the data exchanged between the first radio communication terminal and the second radio communication terminal via the communication link.

6. The device of claim 3, wherein the processor is further configured to:
determine that data is to be transmitted and received over the radio communication network via the communication link;
determine a priority level out of a plurality of priority levels for the at least one data type of data exchanged between the first radio communication terminal and the second radio communication terminal via the communication link; and
determine a priority level out of a plurality of priority levels for different types of further data.

7. The device of claim 6, wherein the processor is further configured to:
determine a common priority list for the different types of data exchanged between the first radio communication terminal and the second radio communication terminal via the communication link and the different types of further data.

8. The device of claim 6, wherein the further data comprises at least one data type from a group consisting of:
voice call data;
video call data;
gaming data;
streaming data; and
office and work data.

9. The device of claim 2,
wherein the radio communication network, the first radio communication terminal and the second radio communication terminal support at least dual band,
wherein the processor is further configured to:
determine a first band on which the data can be exchanged between the first radio communication terminal and the second radio communication terminal; and
determine a second band on which the further data can be transmitted and received, wherein the second band is different from the first band.

10. The device of claim 2,
wherein the radio communication network, the first radio communication terminal and the second radio communication terminal support at least dual band,
wherein the processor is further configured to:
determine a band, based on the first link metrics and the second link metrics, on which the data can be exchanged between the first radio communication terminal and the second radio communication terminal; and
determine a further communication network, different than the radio communication network, to transmit and receive further data.

11. The device of claim 2, wherein the processor is further configured to:
determine a priority level out of a plurality of priority levels for different types of data exchanged between the first radio communication terminal and the second radio communication terminal; and
determine a TCP/IP port for each type of data based on its priority level.

12. The device of claim 1, wherein the processor is further configured to:
determine, at predefined time intervals, the first link metrics for the first plurality of radio communication networks and the second link metrics for the second plurality of radio communication networks; and
select, at predefined time intervals, the radio communication network that is included in the plurality of first radio communication networks and in the plurality of second radio communication networks based on the first link metrics and the second link metrics.

13. The device of claim 1, wherein the processor is further configured to:
select the radio communication network that is included in the plurality of first radio communication networks and in the plurality of second radio communication networks based on a weighted estimation of the first link metrics and the second link metrics.

14. The device of claim 1, wherein the processor is further configured to:
select the radio communication network that is included in the plurality of first radio communication networks and in the plurality of second radio communication networks is based on a weighted average of the first link metrics and the second link metrics.

15. A radio communication terminal device comprising:
a processor configured to:
determine a plurality of first radio communication networks available to the radio communication terminal device;
receive a plurality of second radio communication networks available to a further radio communication terminal device, wherein the plurality of second radio communication networks is at least partially identical to the plurality of first radio communication networks;
determine a first link metric for each of the plurality of first radio communication networks, the first link metric representing a link quality for a respective link between the radio communication terminal device and a respective first radio communication network from the plurality of first radio communication networks;
determine a second link metric for each of the plurality of second radio communication networks, the second link metric representing a link quality for a respective link between the further radio communication terminal device and a respective second radio communication network from the plurality of second radio communication networks;
select a radio communication network that is included in the plurality of first radio communication networks and in the plurality of second radio communication networks based on the first link metrics and the second link metrics;
instruct to establish a communication link from the radio communication terminal device to the radio communication network; and
instruct to send a notification to the further radio communication terminal device instructing the further radio communication terminal device to establish a communication link from the further radio communication terminal device to the radio communication network.

16. The radio communication terminal device of claim 15, wherein the radio communication terminal device is at least one of:
a personal computer, PC;
a mobile device;
an Internet of Things, IoT, device; and
a gaming device.

17. The radio communication terminal device of claim 15, further comprising circuitry for transmitting and receiving configured to:
transmit and receive data over the radio communication network via the communication link with the further radio communication terminal device.

18. The radio communication terminal device of claim 17, wherein the circuitry for transmitting and receiving is further configured to:
transmit and receive further data over a communication network,
wherein the communication network is different than the radio communication network, and
wherein the further data is different than the data exchanged between the radio communication terminal device and the further radio communication terminal device over the radio communication network.

19. A non-transitory computer readable medium comprising instructions which, when executed by one or more processors, are configured to cause the one or more processors to implement a method for selection of a radio communication network, the method comprising:
determining a plurality of first radio communication networks available for a first radio communication terminal;
determining a plurality of second radio communication networks available for a second radio communication terminal, wherein the plurality of second radio communication networks is at least partially identical to the plurality of first radio communication networks;
determining a first link metric for each of the plurality of first radio communication networks, the first link metric representing a link quality for a respective link between the first radio communication terminal and a respective first radio communication network from the plurality of first radio communication networks;
determining a second link metric for each of the plurality of second radio communication networks, the second link metric representing a link quality for a respective link between the second radio communication terminal and a respective second radio communication network from the plurality of second radio communication networks;
selecting a radio communication network that is included in the plurality of first radio communication networks and in the plurality of second radio communication networks based on the first link metrics and the second link metrics; and
instructing the first radio communication terminal and the second radio communication terminal to establish a communication link, wherein the communication link comprises a first link from the first radio communication terminal to the radio communication network and a second link from the second radio communication terminal to the radio communication network.

20. The non-transitory computer readable medium of claim 19, further comprising instructions which, when executed by the one or more processors, implement:
instructing the first radio communication terminal and the second radio communication terminal to provide and receive data via the communication link; and
instructing to operate on the data exchanged between the first radio communication terminal and the second radio communication terminal via the communication link.
